(19) United States
(12) Patent Application Publication
(10) Pub. No.: US 2018/0336336 A1
(43) Pub. Date: Nov. 22, 2018

(54) SYSTEM FOR AUTHENTICATION - BASED FILE ACCESS CONTROL

(71) Applicant: B. G. NEGEV TECHNOLOGIES AND APPLICATIONS LTD., AT BEN-GURION UNIVERSITY, Beer Sheva (IL)

(72) Inventors: Yuval ELOVICI, Arugot (IL); Danny HENDLER, Ness Ziona (IL); Or AMI, Ness Ziona (IL)

(21) Appl. No.: 15/979,907

(22) Filed: May 15, 2018

Related U.S. Application Data
(60) Provisional application No. 62/507,245, filed on May 17, 2017.

(51) Int. Cl. G06F 21/36; G06F 21/62; G06F 21/32

(52) U.S. Cl. CPC G06F 21/36; G06F 21/6218; G06F 2221/2103; G06F 2221/2133; G06F 21/32

(57) ABSTRACT

A system for controlling access to computing-device resources and files based on user authentication, comprising: a) a Policy Specification Interface (PSI) configured to allow an administrator to configure system access policies per execution context, specified as either a program execution path or a process ID; b) a Policy Enforcement Driver (PED) configured to receive input and output (I/O) requests from an I/O manager of the computing device and decide how to handle each I/O request according to the system access policies; and c) a Challenge-Response Generator (CRG) configured to present a challenge to a user in order to recognize a bot or a human user.

### FIELD OF THE INVENTION

The present invention relates to the field of secure computing. More particularly, the invention relates to a system and method for controlling access to files based on user authentication.

### BACKGROUND OF THE INVENTION

Computing devices such as servers, PCs, smartphones etc. provide processes for logging (signing) into the system, based on user credentials (username/password) and/or biometric identification & authentication devices based on fingerprints, facial images, etc. Upon successful login, the user's authenticated identity determines which system resources in general, and system files in particular, the user is authorized to access and in what manner.

Historically, login mechanisms were developed in order to prevent access by unauthorized human users who may have physical access to the device or may access it via a communication network. In recent years, however, the key threats to the security and integrity of computing devices and their files are posed by automated malicious software, bats. The targets of malware often include stealing sensitive data stored in files and preventing system users from accessing this data. Unfortunately, login mechanisms and biometric authentication/authorization devices in contemporary computing devices provide no defense against automated malware attacks.

It is therefore an object of the present invention to provide a system for controlling access to computing-device resources and files based on user authentication.

Other objectives and advantages of this invention will become apparent as the description proceeds.

### SUMMARY OF THE INVENTION

The present invention relates to a system for controlling access to computing-device resources and files based on user authentication, comprising:
a) a Policy Specification Interface (PSI) configured to allow an administrator to configure system access policies;
b) a Policy Enforcement Driver (PED) configured to receive input and output (I/O) requests from an I/O manager of the computing device and decide how to handle each I/O request according to the system access policies; and
c) a Challenge-Response Generator (CRG) configured to present a challenge to a user in order to recognize a bot or a human user.

According to an embodiment of the invention, the CRG comprises one or more challenge-response tests to determine whether or not the user is human and to prevent malicious unauthorized software from accessing files.

According to an embodiment of the invention, the challenge-response tests are selected from the group consisting of: biometric authentication mechanisms, credentials-based login, human identification schemes, or any combination thereof.

According to an embodiment of the invention, the human identification schemes is CAPTCHA or other type of challenge-response test used in computing to determine whether or not the user is human.

In another aspect, the present invention relates to a method for controlling access to computing-device resources and files based on user authentication, comprising: performing, by the computing device: receiving system access policies from a Policy Specification Interface (PSI); receiving, by a Policy Enforcement Driver (PED), input and output (I/O) requests from an I/O manager of said computing device and deciding how to handle each I/O request according to the system access policies; and generating a challenge in a form that is suitable to be presented to a user, by using a Challenge-Response Generator (CRG), in order to recognize a bot or a human user.

According to an embodiment of the invention, the CRG harnesses biometric authentication mechanisms, credentials-based login, and/or human identification schemes, in order to prevent malicious unauthorized software from accessing files.

According to an embodiment of the invention, the method further comprising enforcing file access-control policies based on periodic identification/authorization challenge-response procedures, for ensuring that applications attempting file access are invoked by an authorized user rather than by bots.

According to an embodiment of the invention, the method further comprising flexible configuration options that are configured to allow an administrator to strike a desired balance between the level of disruption incurred by users, resulting from the need to respond to challenges, and the level of security that is gained.

According to an embodiment of the invention, a user may respond to a challenge for a limited period of time, wherein the period of time is configured by an administrator.

In another aspect, the present invention relates to a non-transitory computer-readable medium comprising instructions which when executed by at least one processor causes the processor to perform the method of controlling access to computing-device resources and files based on user authentication.

In yet another aspect, the present invention relates to one or more computer-readable storage devices storing computer-executable instructions that, when executed by one or more processors, cause the one or more processors to perform operations comprising: performing, by the computing device: receiving system access policies from a Policy Specification Interface (PSI); receiving, by a Policy Enforcement Driver (PED), input and output (I/O) requests from an I/O manager of said computing device and deciding how to handle each I/O request according to the system access policies; and generating a challenge in a form that is suitable to be presented to a user, by using a Challenge-Response Generator (CRG), in order to recognize a bot or a human user.

### BRIEF DESCRIPTION OF THE DRAWINGS

In the drawings:

FIG. 1 schematically illustrates a simplistic high-level architecture of the I/O system of a typical computerized device;

FIG. 2 schematically illustrates a high-level structure of a system for authentication-based file access control and its interactions with a computerized system, according to an embodiment of the invention.

FIG. 3 shows a screenshot of a Policy Specification Interface GUI in an exemplary configuration, according to an embodiment of the invention;

FIG. 4 shows a screenshot of an exemplary biometric challenge; and

FIG. 5(A-C) shows a pseudo code of the manner in which file I/O requests are handled according to an embodiment of the present invention.

### DETAILED DESCRIPTION OF THE INVENTION

Reference will now be made to an embodiment of the present invention, examples of which are illustrated in the accompanying figures for purposes of illustration only. One skilled in the art will readily recognize from the following description that alternative embodiments of the structures and methods illustrated herein may be employed, mutatis mutandis, without departing from the principles of the claimed invention.

This system harnesses biometric authentication mechanisms, credentials-based login, and/or human identification schemes such as CAPTCHA (or other types of challenge-response tests used in computing to determine whether or not the user is human), in order to prevent malicious unauthorized software from accessing files. The system enforces file access-control policies based on periodic identification/authorization challenge-response procedures, for ensuring that applications attempting file access are invoked by an authorized user rather than by bots. Via flexible configuration options, the system allows an administrator to strike a desired balance between the level of disruption incurred by users (resulting from the need to respond to challenges) and the level of security that is gained.

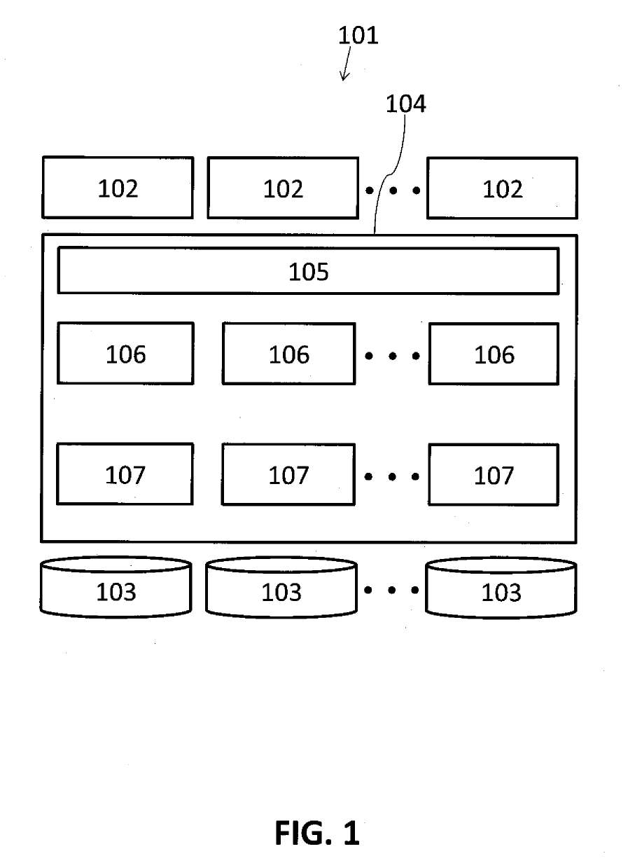

FIG. 1 schematically illustrates a simplistic high-level architecture 101 of the I/O system software of a typical computerized device. Applications 102 operate in user mode wherein their access to system resources (e.g. storage devices 103) is limited. In order to input or output (I/O) in general, or access files in particular, applications must invoke system calls which trigger the execution of operating system (OS) services 104. OS code runs in kernel mode. Unlike code running in user mode, OS code has access to hardware devices. I/O requests are directed to an OS module called the I/O manager 105, which provides interfaces that allow I/O devices (and, in particular, storage devices 103) to be discovered, organized and operated.

When an application issues a system call in order to invoke some operation on a file (e.g., to read the file, write to it or delete it), a corresponding I/O request is generated and delivered to the I/O manager 105 which, in turn, directs the request to a set of device drivers 106 that have registered to handle this type of I/O requests. In modern operating systems, these device drivers are able to perform pre-processing and post-processing prior to dispatching the request to the block device drivers 107 that communicate directly with the appropriate storage device 103.

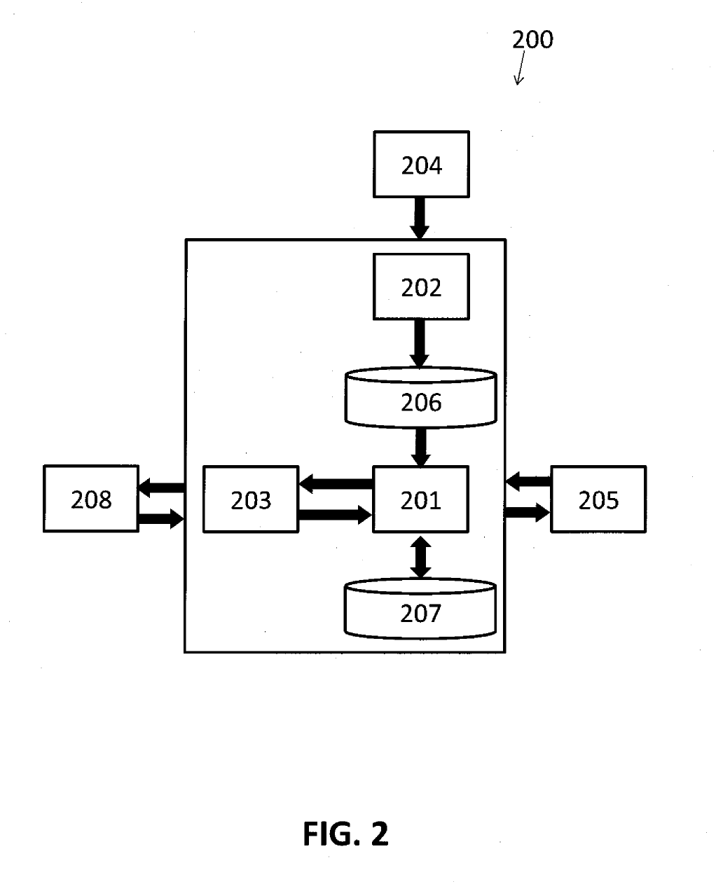

FIG. 2 schematically illustrates a high-level structure of a system 200 for authentication-based file access control and its interactions with a computerized system, according to an embodiment of the invention. System 200 assigns access permits to execution objects based on a policy specified by an administrator 204 and based on responses to challenges that are presented upon attempts to modify or delete files. System 200 comprises a Policy Enforcement Driver (PED) 201, a Policy Specification Interface (PSI) 202, and a Challenge-Response Generator (CRG) 203.

PED 201 is a device driver of system 200 that interacts with the system software in order to enforce file access-control according to policies specified by a system administrator with PSI 202. PED 201 receives file I/O requests from the I/O manager 205 (which corresponds with I/O manager 105 in FIG. 1). Each request specifies the type of the requested file operation and the pathname of the file to which the operation should be applied. PED 201 is further configured to obtain data that identifies the system entity requesting the operation, such as the process ID (PID) and the pathname of the program that invokes the I/O operation. This data is mapped to an execution object 207 and maintains the state of execution objects.

Based on a policy state 206 (edited by the policy specification interface 202) and the execution context state, PED 201 decides how to handle each I/O request. The policy state 206 allows an administrator to specify which file types and/or file directories should be protected and to control the manner in which they will be protected. An execution context can be a process. ID, an executable path, or any other information provided by the OS that identifies the object that issues an I/O request. PED 201 allows read requests to proceed but considers file I/O requests that may allow a program to rename, modify or delete a file based on the policy state 206 (edited by PSI 202, as described below), and the state of the requesting execution object.

By consulting the execution context state and the policy state 206, PED 201 considers the I/O request and may proceed in one of the following manners:
a. The execution context is allowed to make the requested I/O operation and the request is dispatched for execution.
b. The execution context is not allowed to make the requested I/O operation. Depending on policy state 206, an appropriate message may be displayed. The request is not dispatched for execution.
c. A challenge is issued for a user. The type of the challenge (e.g. fingerprint, credentials-based, or CAPTCHA) is determined by the policy and execution context states. The goal of the challenge is to ensure that a user (rather than a bot 208) initiated the file operation and, optionally, to verify that the user is authorized to perform the operation. According to an embodiment of the invention, if a challenge is responded to successfully within a (configurable) period of time, the execution context is allowed to make the access (and is optionally granted a time-limited lease), otherwise the request is refused and is not dispatched for execution.

In either of the above cases, the state of the relevant execution context may be updated to reflect the additional access and, when relevant, the results of the challenge-response. For example, if fingerprint authentication was conducted successfully, the execution context may receive a permit to access read/write files for additional 4 hours.

PSI 202 is a Graphical User Interface (GUI) software program that allows administrator 204 to configure the system's policy. According to an embodiment of the invention, PSI 202 can be invoked only in admin mode. The administrator's selections made using PSI 202 are recorded in the policy state 206 and then used by PED 201 for deciding whether or not to allow file access (as described above) and determine the timing and frequency of invoking CRG 203 for issuing challenges.

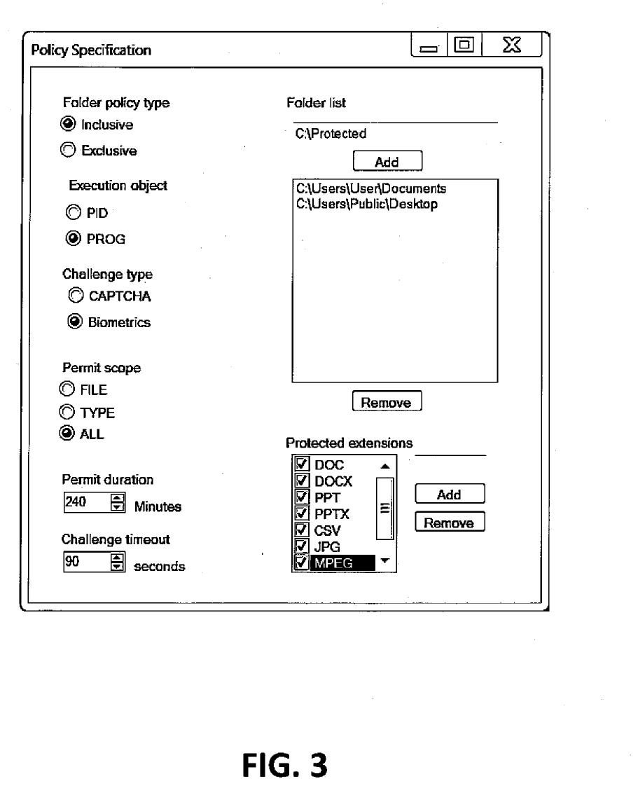

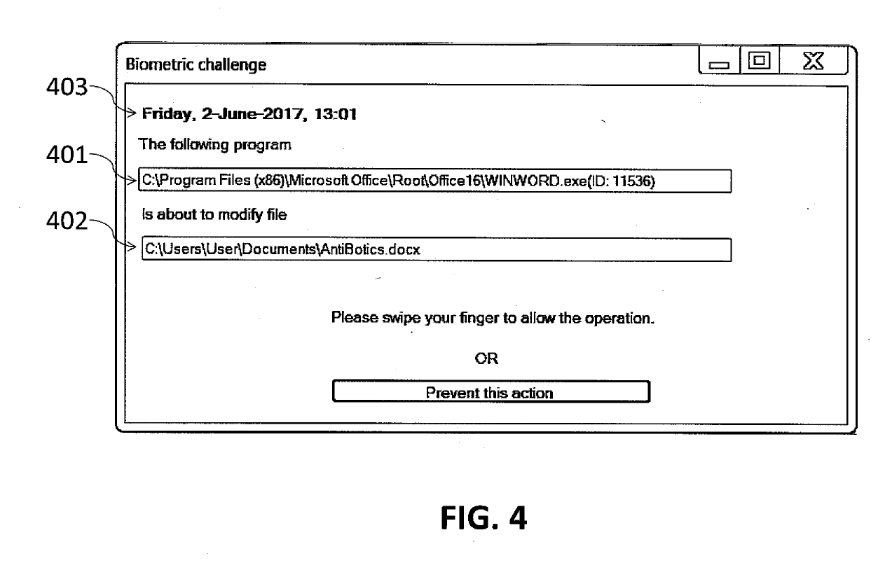

FIG. 3 shows a screenshot of PSI 202's GUI in an exemplary configuration according to an embodiment of the invention, allowing the administrator to configure the following settings:
a. Folder policy type and Folders list parameters specify which folders are and are not protected by the disclosed system. When the Folder policy type parameter assumes value ‘Inclusive’, the default is not to protect and the list specifies the pathnames of specifically protected folders. Otherwise the parameter assumes value ‘Exclusive’ indicating that the default is to protect, and therefore the list specifies the pathnames of folders that are excluded from protection. For example, the AppData folder where Windows® programs often create temporary files may be excluded from protection by including it in the folders list and setting Folder policy type=‘Exclusive’.
b. The Protected extensions parameter is a list of file extensions that are to be protected by the disclosed systems, such as, e.g. those of office documents (.doc*, .xls*), image files (.jpg, .png) or database files (.mdb) to name a few. The Execution object type parameter determines the granularity of authentication. When it assumes value ‘PID’, challenges are issued and permits are granted to specific processes. Otherwise when it assumes value ‘PROG’, signifying that authentication is to be performed in coarser granularity, per executable pathname. The implications of different Execution object type options are described below.
c. The Challenge type parameter specifies the type of challenges issued by the disclosed system. Exemplary authentication challenges are illustrated in FIG. 4 including CAPTCHA and Biometrics (e.g. fingerprint scanning), although the present invention is not limited to a specific challenge or group of challenges. The Challenge timeoue parameter determines the period of time (in seconds) within which a user must respond to a challenge.
d. The Permit duration parameter specifies the duration (in minutes) of the permit granted to an execution object. The Permit scope parameter determines which files an execution object that is granted a permit may access as long as the permit is active (i.e. not expired). The permit can be either limited to the file that triggered the challenge (FILE), limited to files of the same type (TYPE), or allow access to any file type (ALL).

According to an embodiment of the invention, CRG 203 is invoked by PED 201 in admin mode whenever the latter concludes (after consulting the policy state 206 and the execution object states data structure) that an attempt to modify or delete a file made by an execution context shouldn't be allowed to proceed before a new challenge is successfully responded to.

The authentication method used by the challenge is determined according to the policy state 206. FIG. 4 shows a screenshot of an exemplary biometric challenge. According to an embodiment of the invention, the challenge provides the user with the following information:
identification of the execution context (e.g., program pathname, process ID, and requested operation) 401;
name of the file to which access is requested 402; and
time of access attempt 403.

If a challenge is responded to successfully within the time interval configured in the policy state 206, a positive response is sent to PED 201. Otherwise, when the timeout expires, a negative response is sent to PED 201. According to an embodiment of the invention, the challenge window remains on screen so that if and when the user will attempt to respond to the challenge, a message will be sent stating that it was timed-out and a new challenge will be introduced. A rate-limiting mechanism prevents execution contexts from generating challenges at a too-high rate.

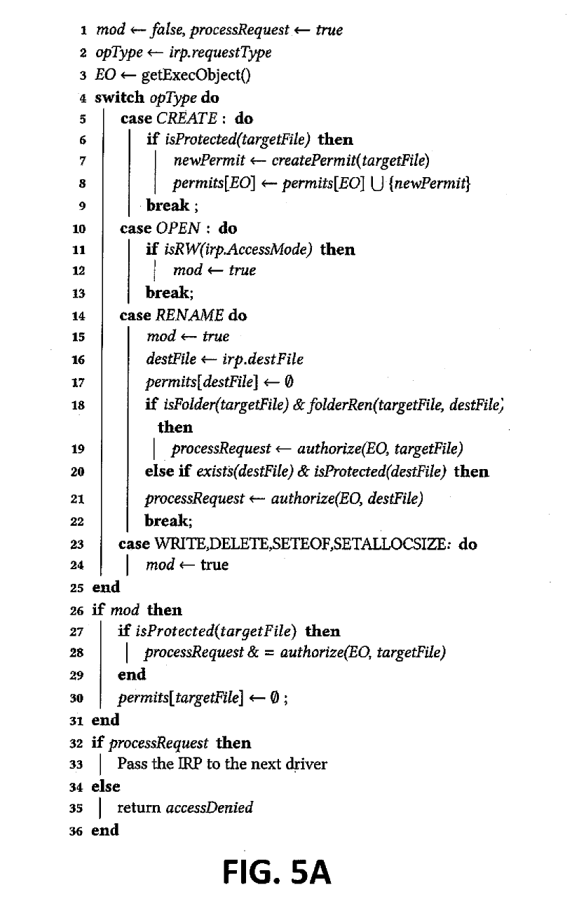

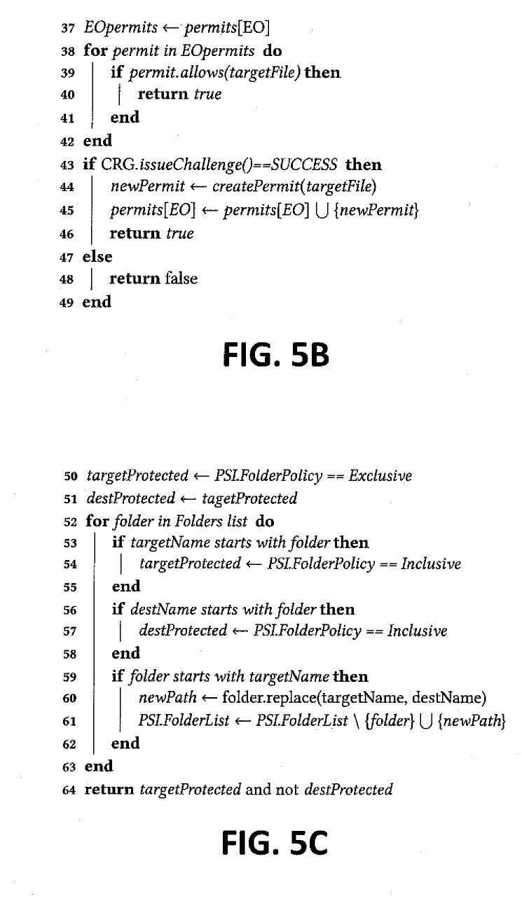

FIG. 5A shows a pseudo code of the manner in which PED 201 handles file I/O requests according to an embodiment of the present invention. The input consists of the pathname of the file to which the operation is supposed to be applied (targetFile) and the I/O Request Packets (IRP) structure.

Handling a file I/O request begins with obtaining the execution object (line 3). Execution then switches according to the type of the requested operation. If file creation is attempted and the policy specifies that the file is to be protected, a permit for the new file is automatically generated and associated with the execution object (lines 5-9). This allows programs to modify the files they created without presenting challenges to the user, as long as the permit generated upon creation remains active. According to an embodiment of the invention, a hash map (permits) that maps execution objects to their sets of permits is maintained. This enables quick lookups of execution object permits.

When an execution object attempts to open a protected file (line 10), the disclosed system checks if the file is about to be opened with write permission (line 11), in which case a permit for opening the file may be required and the mod flag is set in line 12 to ensure that the target file is handled further in lines 27-30. According to an alternative embodiment of the invention, lazy protection is implemented by allowing the file open to succeed and enforce protection only when the execution object invokes a write operation. This strategy, however, might not work against some existing ransomware.

Moving a file from one position to another in the directories' hierarchy is technically a rename operation applied to the file. Rename operations must be protected against malicious use. As an example, considering a file named File.txt in a folder C:\FolderA. In order to move this file to folder C:\FloderB, one can rename the file's pathname from C:\FolderA\File.txt to C:\FolderB\File.txt. If a file with the destination pathname already exists, an override option is available that overwrites this file. Indeed some ransomware use this option in order to delete user files without explicitly invoking a delete or write operation. Consequently, if a rename request requires modifying or overriding a protected file, the execution object must hold an active permit for the destination file (As well as for the target).

Rename operation are the more complicated case and are dealt with, according to an embodiment of the present invention, as follows. First the mod flag is set in line 15 to ensure that the file to which the rename operation is applied (the target file) is handled further in lines 27-30. Then, if the destination file is an execution object, all its permits are deleted in lines 16-17 (if it is not an execution object, then these two lines have no effect). This is in order to block possible future path hijacking attacks that attempt “stealing” system permits. If the operation is about to rename a folder, the folderRen function is called (in line 18, assuming that the expressions are evaluated in this line left to right) in order to block possible future folder exclusion attacks.

The folderRen function is described shortly. If it returns true, signifying that the rename is about to remove protection for some files in the renamed folder, the authorize function (described below) is called to determine whether the folder rename should be allowed (line 19). Otherwise, if the destination file exists and should be protected (line 20), the authorize function is called to determine whether overwriting it should be allowed (line 21).

When an execution object attempts to perform either one of the WRITE, DELETE, SETEOF or SETALLOCATIONSIZE operation types (the latter two change the file's size), it is noted by the disclosed system that the execution object requests to modify the target file (lines 23-24).

After exiting the switch of lines 4-25 the algorithm proceeds to checking whether the target file is about to be modified (line 26) in which case, if it should be protected (line 27) the authorize function is invoked to determine whether modification should be allowed and its response is recorded in the processRequest flag (line 28).

If the target is an execution object, all its permits are deleted in line 30 in order to block path hijacking attacks against the system. Finally, if access is to be allowed to both target and destination files (in rename operations), the IRP is passed on to the next stack driver, otherwise the requested access is denied (lines 32-36).

FIG. 58 shows a pseudo code of the authorize function that is called (in lines 21 and 28 of the algorithm of FIG. 5A) for determining whether or not a file I/O request should be authorized. It receives as operands a reference to the execution object EO that made the request and the name of the targetFile.

First, the permits of the execution object are retrieved (line 37). If at least one of these permits allows modifying/deleting targetFile, authorize returns true, notifying handleRequest that access is authorized (lines 38-42). If no such permit exists, CRG 203 is invoked for issuing a new challenge in line 43.

If the challenge was responded to successfully within the challenge timeout, CRG 203 returns a SUCCESS indication, in which case a new permit for the target file is created and added to the execution object's permits set and authorize returns true (lines 44-46), notifying handleRequest that the request is authorized, otherwise false is returned (line 48), notifying handleRequest that the request should be rejected.

FIG. 5C shows a pseudo code of the folderRen function that is called in line 18 of handleRequest when a folder is about to be renamed. Its tasks are to update PSI 202's folder list if required, and to determine if the rename might be a folder exclusion attack for removing file protection. To perform its first task the function iterates over the PSI folders list (lines 52-63) in order to find paths that are descendants of targetFile and update their pathname.

To perform its second task, folderRen checks in line 64 whether the target folder is protected but will lose its protection after being renamed and returns true or false accordingly.

The system and method for authentication-based file access control, as described hereinabove, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the disclosure.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a USB disk-on-key device or an optical disk drive. The storage device can be other similar means for loading computer programs or other instructions into the computer system.

The computer system executes a set of instructions that are stored in one or more storage elements to process input data. These storage elements can also hold data or other information, as desired, and may be in the form of an information source or a physical memory element present in the processing machine. Exemplary storage elements include a hard disk and a DRAM. The storage element may be external to the computer system and connected to or inserted into the computer, to be downloaded at or prior to the time of use. Examples of such external computer program products are computer-readable storage mediums such as CD-ROMS, Flash chips, and the like.

The set of instructions may include various commands that instruct the processing machine to perform specific tasks such as the steps that constitute the method described hereinabove. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions can be embedded in a computer program product for use with a computer, the computer program product comprising a computer-usable medium with a computer-readable program code embodied therein. Processing of input data by the processing machine maybe in response to users' commands, results of previous processing, or a request made by another processing machine.

The modules described herein may include processors and program instructions that are used to implement the functions of the modules described herein. Some or all the functions can be implemented by a state machine that has no stored program instructions, or in one or more Integrated Circuits (ICs), in which each function or some combinations of some of the functions are implemented as custom logic.

Although embodiments of the invention have been described by way of illustration, it will be understood that the invention may be carried out with many variations, modifications, and adaptations, without exceeding the scope of the claims.

1. A system for controlling access to computing-device resources and files based on user authentication, comprising:
a) a Policy Specification Interface (PSI) configured to allow an administrator to configure system access policies per execution context, specified as either a program execution path or a process ID;
b) a Policy Enforcement Driver (PED) configured to receive input and output (I/O) requests from an I/O manager of the computing device and decide how to handle each I/O request according to the system access policies; and
c) a Challenge-Response Generator (CRG) configured to present a challenge to a user in order to recognize a bot or a human user.

2. The system according to claim 1, wherein the CRG comprises one or more challenge-response tests to determine whether or not the user is human and to prevent malicious unauthorized software from accessing files.

3. The system according to claim 2, wherein the challenge-response tests are selected from the group consisting of: biometric authentication mechanisms, credentials-based login, human identification schemes, or any combination thereof.

4. The system according to claim 3, wherein the human identification schemes is CAPTCHA or other type of challenge-response test used in computing to determine whether or not the user is human.

5. A method for controlling access to computing-device resources and files based on user authentication, comprising: performing, by the computing device: receiving system access policies from a Policy Specification interface (PSI); receiving, by a Policy Enforcement Driver (PED), input and output (I/O) requests from an I/O manager of said computing device and deciding how to handle each I/O request according to the system access policies; and generating a challenge in a form that is suitable to be presented to a user, by using a Challenge-Response Generator (CRG), in order to recognize a bot or a human user.

6. The method according to claim 5, wherein the CRG harnesses biometric authentication mechanisms, credentials-based login, and/or human identification schemes, in order to prevent malicious unauthorized software from accessing files.

7. The method according to claim 5, further comprising enforcing file access-control policies based on periodic identification/authorization challenge-response procedures, for ensuring that applications attempting file access are invoked by an authorized user rather than by bots.

8. The method according to claim 5, further comprising flexible configuration options that are configured to allow an administrator to strike a desired balance between the level of disruption incurred by users, resulting from the need to respond to challenges, and the level of security that is gained.

9. The method according to claim 5, wherein a user may respond to a challenge for a limited period of time, wherein the period of time is configured by an administrator.

10. A non-transitory computer-readable medium comprising instructions which when executed by at least one processor causes the processor to perform the method of claim 5.

11. A system, comprising:
a) at least one processor; and
b) a memory comprising computer-readable instructions which when executed by the at least one processor causes the at least one processor to execute access control to computing-device resources and files based on user authentication, wherein the access control:
i. receives system access policies from a Policy Specification Interface (PSI);
ii. receives, by a Policy Enforcement Driver (PED), input and output (I/O) requests from an I/O manager of said computing device and decides how to handle each I/O request according to the system access policies; and
iii. generates a challenge in a form that is suitable to be presented to a user, by using a Challenge-Response Generator (CRG), in order to recognize a bot or a human user.
